(19) United States
(12) Patent Application Publication
(10) Pub. No.: US 2007/0061509 A1
(43) Pub. Date: Mar. 15, 2007

(54) Power management in a distributed file system

(76) Inventors: Vikas Ahluwalia, Kirkland, WA (US); Vipul Paul, Hillsboro, OR (US); Scott A. Piper, Bothell, WA (US)

Correspondence Address: LIEBERMAN & BRANDSDORFER, LLC, 802 STILL CREEK LANE, GAITHERSBURG, MD, 20878, US

(21) Appl. No.: 11/223,559

(22) Filed: Sep. 9, 2005

(51) Int. Cl. G06F 12/00; G06F 13/00

(52) U.S. Cl. 711/112; 711/113

(57) ABSTRACT

A method and system are provided for managing a spin state of individual physical disks in a distributed file system. Spin control messages are forwarded to a specified physical disk asynchronously with an I/O command and prior to receipt of the data request by the physical disk. This enables the spin state of the physical disk to be responsive to the I/O command with minimal delay.

### BACKGROUND OF THE INVENTION

1. Technical Field

This invention relates to managing activity of physical storage media. More specifically, the invention relates to controlling speed of operation of physical storage media in a distributed file system that support simultaneous access of the storage media by two or more client machines.

2. Description Of The Prior Art

Most personal computers include physical storage media in the form of at least one hard disk drive. When the personal computer is operating, one hard disk consumes between 20 and 30 percent of the total power of the personal computer. Different techniques are known in the art of managing personal computers to reduce the operating speed of the hard disk to an idle state when access to the hard disk is not required, and to increase the operating speed of the hard disk when access to the hard disk is required. Management of the speed of the hard disk enables greater operating efficiency of a personal computer.

FIG. 1 is a prior art block diagram (10) of a distributed file system including a server cluster (20), a plurality of client machines (12), (14), and (16), a storage area network (SAN) (30), and a separate metadata storage (42). Each of the client machines communicate with one or more server machines (22), (24), and (26) in a server cluster (20) over a data network (40). Similarly, each of the client machines (12), (14), and (16) and each of the server machines in the server cluster (20) are in communication with the storage area network (30). The storage area network (30) includes a plurality of shared disks (32) and (34) that contain only blocks of data for associated files. Similarly, the server machines (22), (24), and (26) manage metadata located in the meta data storage (42) pertaining to location and attributes of the associated files. Each of the client machines may access an object or multiple objects stored on the file data space (38) of the SAN (30), but may not access the metadata storage (42). In opening the contents of an existing file object on the storage media in the SAN (30), a client machine contacts one of the server machines to obtain object metadata and locks. Typically, the metadata supplies the client with information about a file, such as its attributes and location on storage devices. Locks supply the client with privileges it needs to open a file and read and/or write data. The server machine performs a look-up of metadata information for the requested file within metadata storage (42). The server machine communicates granted lock information and file metadata to the requesting client machine, including the addresses of all data blocks making up the file. Once the client machine holds a lock and knows the data block address or addresses, the client machine can access the data for the file directly from a shared storage device (32) or (34) attached to the SAN (30). The quantity of elements in the system (10), including server nodes in the cluster, client machines, and storage media are merely an illustrative quantity. The system may be enlarged to include additional elements, and similarly, the system may be reduced to include fewer elements. As such, the elements shown in FIG. 1 are not to be construed as a limiting factor.

As shown in FIG. 1, the illustrated distributed file system separately stores metadata and data. In one example, one of the servers in the server cluster (20) holds information about shared objects, including the addresses of data blocks in storage that a client may access. To read a shared object, the client obtains the file's metadata, including data block address or addresses from the server, and then reads the data from the storage at the given block address or addresses. Similarly, when writing to a shared object, the client requests that the server creates storage block addresses for data and then requests the allocated block addresses to which the data will then be written. The metadata may include information pertaining to the size, creation time, last modification time, and security attributes of the object.

In a distributed file system, such as the one shown in FIG. 1, the SAN may include a plurality of storage media in the form of disks. Power consumption of a hard disk in a desktop computer system is about 20-30% of the total system power. Given the quantity of hard disks in a SAN, it is clear that there is a lot of system power to be harnessed. One prior art method for harnessing power associated with storage media in a SAN includes spinning down a disk if it has not been used for a set quantity of time. When access to the disk is needed, the disk is spun up and when the disk attains the proper speed it is ready to receive data. However, this method involves a delay while the disk changes from an inactive state to an active state. The delay in availability of the storage media affects response time and system performance. In a distributed file system with a plurality of client machines and a SAN with a plurality of hard disks, a single client machine cannot effectively manage power operations of each hard disk in the SAN that may be shared with other client machines. Accordingly, there is a need for a method and/or manager that can effectively manage the speed and operation of each hard disk in a SAN without severely impairing response time and system performance.

### SUMMARY OF THE INVENTION

This invention comprises a method and system for addressing control of a spin state of physical storage media in a storage area network simultaneously accessible by multiple client machines.

In one aspect of the invention, a method is provided for managing power in a distributed file system. The system supports simultaneous access to storage media by multiple client machines. A spin-state of a physical disk in the storage media is asynchronously controlled in response to a data access request.

In another aspect of the invention, a computer system is provided including a distributed file system having at least two client machines in simultaneous communication with at least one server and physical storage media. A manager is provided in the system to asynchronously control a spin-state of a physical disk in the storage media in response to presence of activity associated with the disk.

In yet another aspect of the invention, an article is provided with a computer useable medium embodying computer usable program code for managing power in a distributed file system. The program code includes instructions to support simultaneous access to storage media by multiple client machines. In addition, the program code includes instructions for asynchronously controlling a spin-state of a physical disk in the storage media responsive to a data access request.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a distributed file system.

FIG. 2 is block diagram of a server machine and a client machine in a distributed file system.

FIG. 3 is a flow chart demonstrating processing of a read command with storage media power management.

FIG. 4 is a flow chart demonstrating processing of a write command with storage media power management.

FIG. 5 is a flow chart demonstrating processing of a write command with respect to cached data and with storage media power management.

FIG. 6 is a flow chart demonstrating a process for translating a logical extent to a physical extent.

FIG. 7 is a block diagram illustrating the components of the monitoring table.

FIG. 8 is a flow chart illustrating a process for monitoring disk activity of the physical disks in the SAN according to the preferred embodiment of this invention, and is suggested for printing on the first page of the issued patent.

### DESCRIPTION OF THE PREFERRED EMBODIMENT

### Overview

Shared storage media, such as a storage area network, generally includes a plurality of physical disks. Controlling the spin-state of each of the physical disks in shared storage manages power consumption and enables efficient handling of storage media. A spin-up command may be communicated to individual physical disks in an idle state asynchronously with a read and/or write command to avoid delay associated with activating an idle disk. Accordingly, power management in conjunction with asynchronous messaging is extended to the individual physical disks, and more particularly to the spin-state of individual storage disks of a shared storage system.

### Technical Details

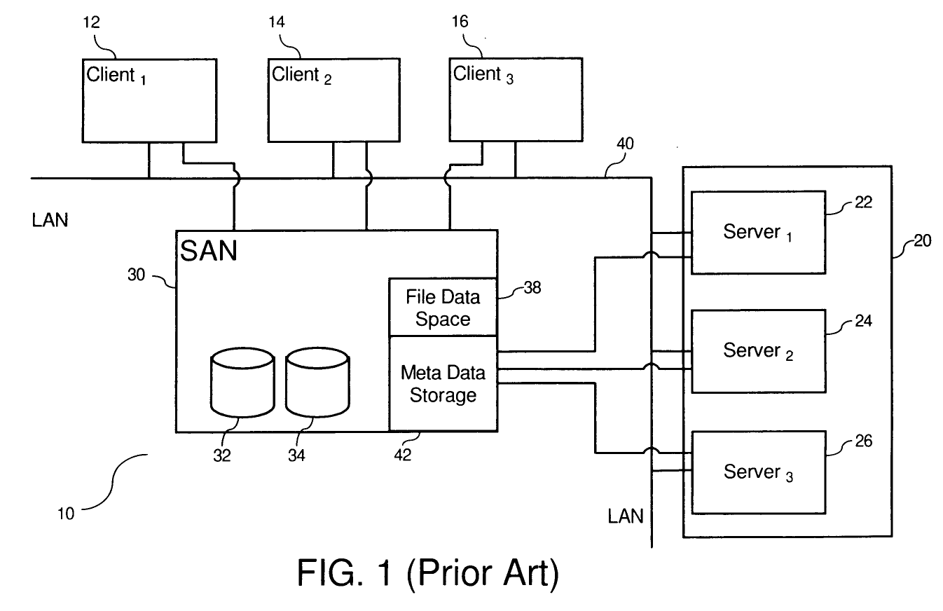

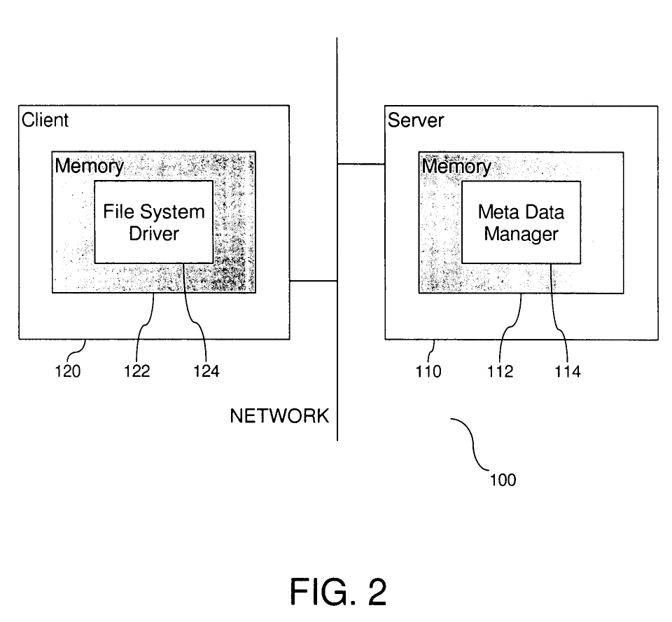

FIG. 2 is a block diagram (100) of an example of a server machine (110) and a client machine (120) in communication across the distributed file system of FIG. 1. The server machine (110) includes memory (112) and a metadata manager (114) in the memory (112). In one embodiment, the metadata manager (114) is software that manages the metadata associated with file objects. The client machine (120) includes memory (122) and a file system driver (124) in the memory. In one embodiment, the file system driver (124) is software for facilitating an I/O request. Memory (122) provides an interface for the operating system to read and write data to storage media. In one embodiment, such as a file system that restricts access to objects to one client at a time, the metadata manager may be part of the file system driver.

A read or write access request to a file object is known as an I/O request. When an I/O request is generated, the client machine's operating system is responsible for processing this request and for redirecting the request to the file system driver (124). The I/O request includes the following parameters: object name, object offset to read/write, and size of the object to read/write. The object offset and the size of the object are referred to as a logical extent as they are in reference to a logical contiguous map of the file object space on a logical volume or a disk partition. In general, a logical extent is concatenated together from pooled physical extents, i.e. a contiguous area of storage in a computer file system reserved for a file. Upon receipt of the I/O request by the operating system, the I/O request is forwarded to the file system driver (124) managing the logical volume of associated file objects. In one embodiment, there may be a plurality of client machines and the I/O request is directed to the file system driver which manages the logical volume on which the file object resides. The request is communicated from the file system driver (124) to the metadata manager (114) which converts the I/O file system parameters into the following: disk number, disk offset read/write, and size of object to read/write. The disk number, disk offset read/write, and size of the object to read/write are referred to as the physical extent. Accordingly, the file system driver functions to convert a logical extent of an I/O request to one or more physical extents.

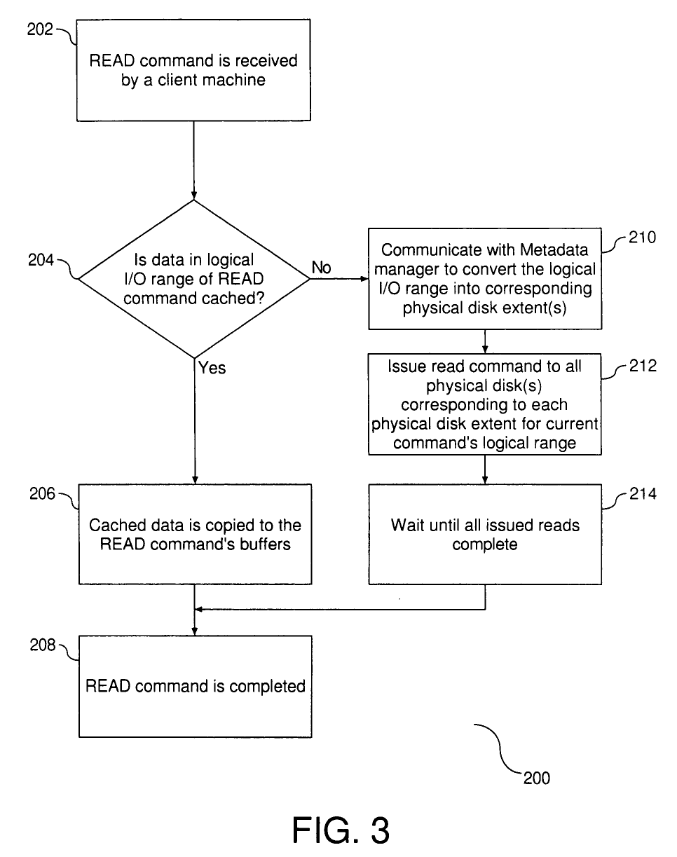

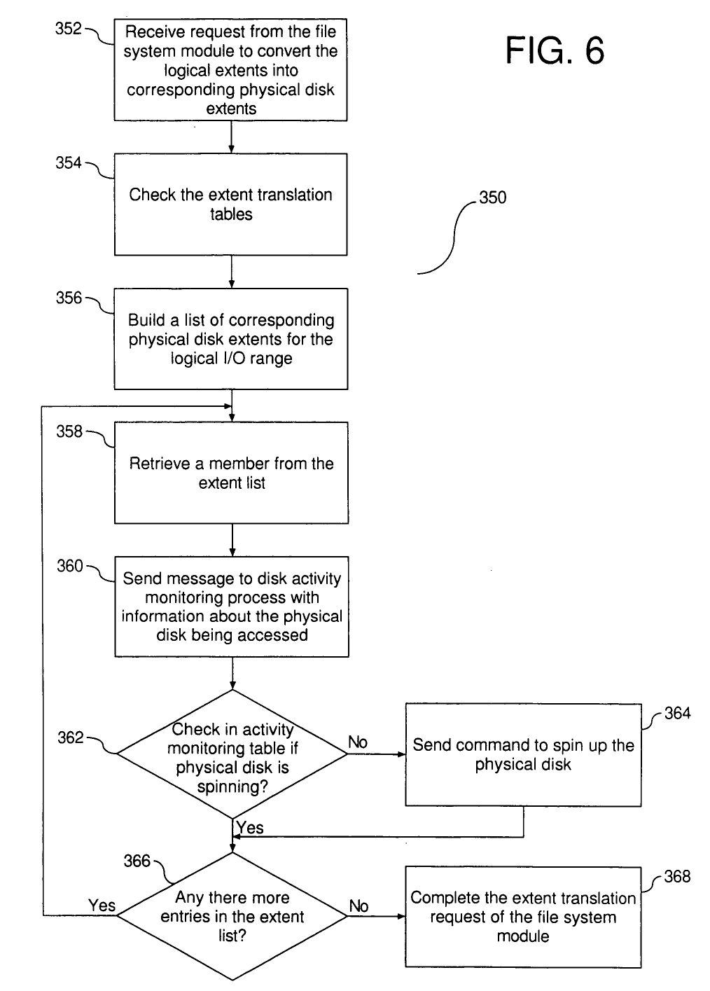

FIG. 3 is a flow chart (200) illustrating a process for handling a read request in a distributed file system in conjunction with management of physical storage media. Initially, a read command is received by a client machine (202). Following receipt of the read command, a test is conducted to determine if the data requested from the read command can be served from cached data (204). If the response to the test at step (204) is positive, the cached data is copied to the buffer of the read command (206), and the read command is completed (208). However, if the response to the test at step (204) is negative, a communication is forwarded to a metadata manager residing on one of the servers to convert a logical I/O range of the read command into corresponding physical disk extents in the physical storage media (210). In one embodiment, the communication is communicated from the file system driver to the metadata manager. Details of translation of the logical extents is shown in FIG. 6. Subsequent to the translation at step (210), a read command is issued to all physical disks corresponding to each physical disk extent for the logical range of the current command (212). In one embodiment, the physical disk servicing the I/O command receives an asynchronous communication from the metadata manager to ensure the disk is in a proper spin state prior to receipt of the I/O command. The client waits until all issued reads of the disk extents are complete (214). Following completion of all issued reads at step (214) or copying cached data to the buffer of the read command at step (206), the read command is complete. Accordingly, a read in the file system module communicates with the metadata manager to obtain the physical disk extents to fulfill the read command if the data is not present in cache memory.

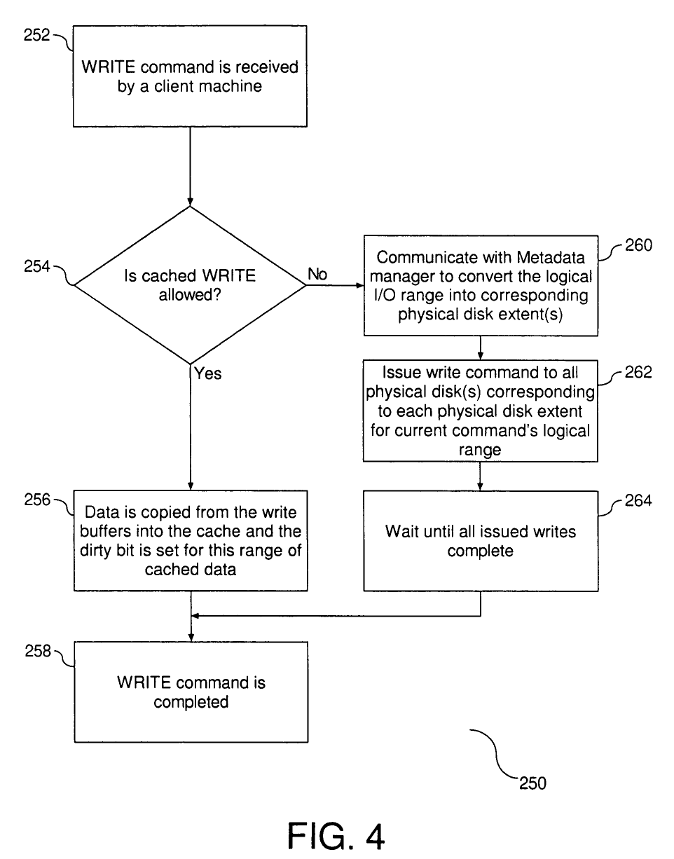

FIG. 4 is a flow chart (250) illustrating a process for handling a write request in a distributed file system in conjunction with management of physical storage media. Initially, a write command is received by a client machine (252). Following receipt of the write command, a test is conducted to determine if the data requested from the write command can be cached (254). If the response to the test at step (254) is positive, the data is copied from the write buffer(s) into the cache and a dirty bit is set for the specified range of cached data (256), and no disk I/O occurs. Following the step of setting the dirty bit, the write command is complete (258). However, if the response to the test at step (254) is negative, a communication is forwarded to the metadata manager residing on one of the servers to translate a logical I/O range of the write command into corresponding physical disk extents (260). Details of translation of the logical extents is shown in FIG. 6. Subsequent to the translation at step (260), a write command is issued to all physical disks corresponding to each physical disk extent for the logical range of the current command (262). In one embodiment, the physical disk servicing the I/O command receives an asynchronous communication from the metadata manager to ensure the disk is in a proper spin state prior to receipt of the I/O command. Thereafter, the client waits until all issued writes of the disk extents are complete (264). Following completion of all issued writes of the disk extents at step (264) or setting of the dirty bit at step (256), the write command is complete. Accordingly, a write in the file system module communicates with the metadata manager to obtain the physical disk extents to fulfill the write command if the data is not to be written to cache memory but straight to disk.

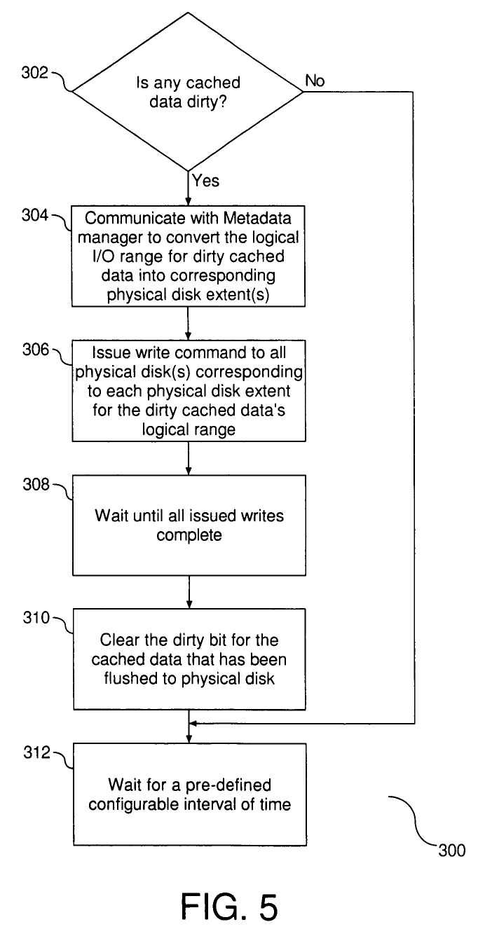

In addition to the write process shown in FIG. 4, there is an alternative write process that pertains to management of cached data. This process is scheduled by the file system driver at regular interval of time. FIG. 5 is a flow chart (300) illustrating this alternative write process. Initially, a test is conducted to determine if any cached data has a dirty bit set (302). A positive response to the test at step (302) follows with a communication to the metadata manager to convert the logical I/O range for the dirty cached data into corresponding physical disk extents (304). Details of translation of the logical extents is shown in FIG. 6. Thereafter, a write command is issued to all physical disks corresponding to each physical disk extent for the logical range of the dirty cache data current command (306). In one embodiment, the physical disk servicing the I/O command receives an asynchronous communication from the metadata manager to ensure the disk is in a proper spin state prior to receipt of the I/O command. Thereafter, the client waits until all issued writes of the disk extents are complete (308) and the write command is complete. Following step (308), the dirty bit for the cached data that has been flushed to one or more physical disks is cleared (310). If the response to the test at step (302) is negative, or following clearing of the cached data dirty bit at step (310), the process waits for a pre-defined configurable interval of time (312) before returning to step (302) to determine presence of dirty cache data. Accordingly, the process outlined in FIG. 5 pertains to cached data and more specifically to communicating conversion of a logical I/O range to one or more physical disk extent(s) for dirtied cached data.

Translation of the logical extents to the physical extents is handled by the metadata manager module. In one embodiment, the metadata manager module is a software component that resides within memory of one of the servers, as shown in FIG. 2. FIG. 6 is a flow chart (350) illustrating a process for translating a logical extent to a physical extent according to a preferred embodiment of this invention. Upon receipt of a request from the file system module to convert logical extents into corresponding physical disk extents (352), as shown at steps (210), (260), and (304), an extent translation table(s) is checked (354) and a list of corresponding physical disk extents for the logical I/O range are built (356). This extent translation table is part of metadata storage. The metadata manager reads the extent translation table from the metadata storage on the SAN. Thereafter, a physical member is retrieved (358) from the extent list built at step (356), followed by sending a message to the metadata manager with information about the physical disk being accessed (360). Such information may include an address of the physical disk where the I/O needs to occur.. A test is then conducted to determine if the physical disk from step (360) is spinning (362). In one embodiment, a disk activity table is maintained in memory on one of the servers in the cluster. The disk activity table stores a spin state of the disk, as well as a timer to monitor activity or inactivity over a set period of time. A negative response to the test at step (362) will result in the metadata manager sending a command to the physical disk to increase it's speed, i.e. spin-up (364). Once the disk is spinning, the requesting client can efficiently use the physical disk. Following step (364) or a positive response to the test at step (362), a subsequent test is conducted to determine if there are more entries in the extent list (366). A positive response to the test at step (366) will return to step (358) to retrieve the next member in the extent list, and a negative response to the test at step (366) will result in completion of the extent transaction request (368). Accordingly, the metadata manager is responsible for spinning up a physical disk associated with a member in the returned extent list.

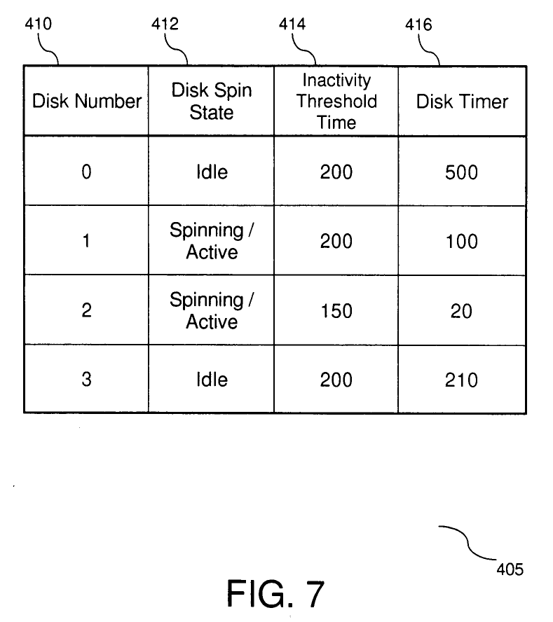

As shown above, a physical disk may receive a command to increase its speed, i.e. spin-up, in response to receipt of a read or write command. In one embodiment, a disk activity monitoring table is provided to track the speed of physical disks in the file system. FIG. 7 is a block diagram (400) illustrating an example of the components of the monitoring table (405). In one embodiment, the table is stored in memory of one of the servers. As shown, the table (405) includes the following four columns: disk number (410), disk spin state (412), inactivity threshold time (414), and disk timer (416). The disk number column (410) stores the number assigned to each disk in shared storage. The disk spin state column (412) stores the state of the respective disk. The inactivity threshold time column (414) stores the minimum time interval for a respective disk to remain inactive to be placed in an idle state from an active state. The disk timer column (416) stores the elapsed time interval since the respective disk was last accessed (416). When the disk timer value exceeds the inactivity threshold time value, the respective disk is placed in an idle state. Conversely, if the inactivity threshold time is greater than the disk timer, the respective disk remains in an active spinning state. For example, as shown in the first row, the disk timer has a value of 500 and the inactivity threshold is set to 200. As such, the associated disk is placed in an idle state since the disk timer value exceeds the threshold time value and the spin state is reflected in the table. Accordingly, the disk activity table monitors the state of each disk in shared storage.

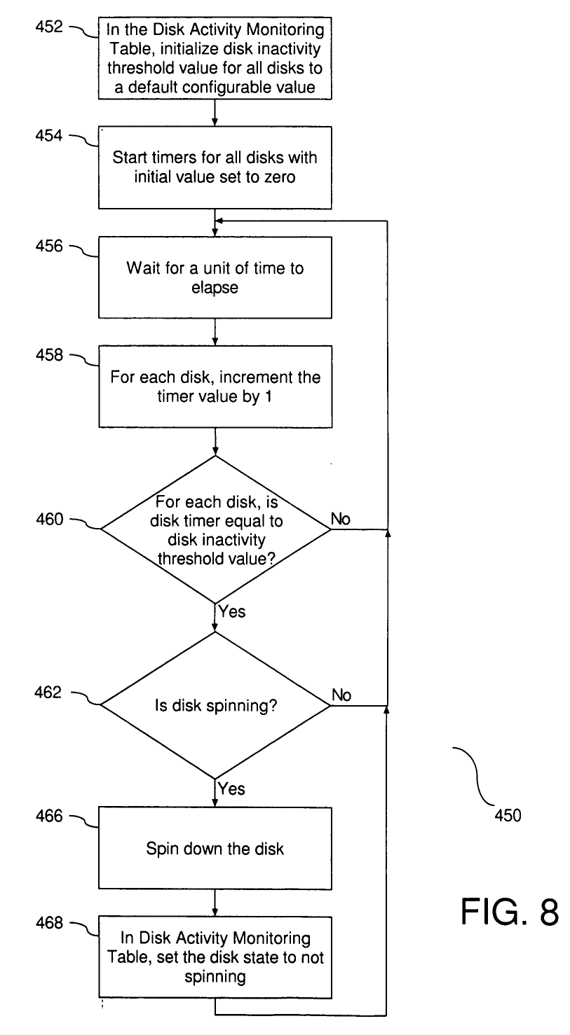

FIG. 8 is a flow chart (450) illustrating an example of a process for monitoring disk activity of the physical disks in the SAN. Initially, a threshold value is set for inactivity of each disk (452). In one embodiment, at start time of a client machine, the client machine communicates its desired idle time for physical disks to the metadata manager. Homogenous clients, i.e. of the same operating system, may be configured for different idle times. The threshold value sets the time period after which an inactive disk will be placed in an idle state. When the metadata manager sees a disk inactive for a time greater than its threshold time, the metadata manager spins down the inactive disk. A disk in an idle state consumes less power than a disk in an active state. For example, if a physical disk remains inactive for 2 minutes and its idle time was set at 1 minute, its spin-state may be slowed to an idle state until such time as an I/O request requires the physical disk to be spun up to serve a data request. Following the threshold establishment at step (452), a timer is set for each physical disk, with the initial value of the timer being zero (454). A unit of time is allowed to elapse (456), after which the timer value is incremented by a value of one for each disk (458). Following the increment at step (458), a test is conducted to determine if the disk timer is greater than the disk inactivity threshold set at step (452) for each disk being monitored (460). A negative response to the test at step (460) will follow with a return to step (456). This indicates that none of the physical disks being monitored have been idle for a period of time greater than the threshold value set at step (452). However, a positive response to the test at step (460) will follow with a subsequent test to determine if each of the disks that have been idle for a time greater than the set threshold value is spinning (462). A spinning inactive disk wastes energy. If the disk is not spinning, the process returns to step (456) to continue monitoring the spin state of each monitored disk. However, if at step (462) it is determined that an inactive disk is spinning, a command is forwarded to spin down the inactive disk (464). The act of spinning down the disk is followed by setting the disk state of the disk in the table to a not spinning state, i.e. idle state (466). After the disk has been placed in an idle state and this change has been recorded in the disk activity table, the process returns to step (456) to continue the monitoring process. Accordingly, the spin state control process entails tracking the activity of physical disks and spinning down the disks if they remain in an inactive state beyond a set threshold time interval.

Asynchronous messaging techniques prior to receipt of the I/O command by the physical disk assigned to service the command enables management of physical disks without delay in servicing an I/O command. One example of use of the asynchronous messaging technique is when a new client has started. At start time of a client machine, the client machine communicates its desired idle time for physical disks to the metadata manager. This communication is recorded in the disk activity table managed by the metadata manager. In one embodiment, the client communication to the metadata manager may occur asynchronously to update the disk inactivity threshold value for all disks to a client specified preference. Another example of use of an asynchronous messaging technique is when the metadata manager receives a notification that a disk needs to be accessed. This notification may be communicated asynchronously to the metadata manager. Such a notification preferably includes instructions to reset the time count to zero for the physical disk being accessed and to set the physical disk to a spin-state. By forwarding these outlined messages to the metadata manager asynchronously, a received I/O command can be serviced without delay since it provides an otherwise idle disk time to be spun up prior to servicing the command. Accordingly, implementation of asynchronous messaging techniques enables control of the spin-state of individual physical storage disks with minimal or no delay in servicing an I/O command.

### Advantages Over The Prior Art

The metadata manager directs I/O associated with read and write commands to physical storage media. The metadata manager maintains a disk activity table and consults the table to determine the spin-state of the physical storage media prior to issuing an I/O command. Similarly, if the disk is in an idle state and there is no alternative physical disk available in an active spin-state, the metadata manager may issue an asynchronous message to a specified disk to start the spin-up process prior to issuing the I/O command. The issuance of the asynchronous message avoids delay associated with spin-up of a physical disk. Accordingly, the physical spin-state of disks in shared storage are monitored and controlled through the metadata manager to efficiently manage power consumption associated therewith.

In one embodiment, the metadata manager (114) and the file system driver (116) may be software components stored on a computer-readable medium as it contains data in a machine readable format. For the purposes of this description, a computer-useable, computer-readable, and machine readable medium or format can be any apparatus that can contain, store, communicate, propagate, or transport the program for use by or in connection with the instruction execution system, apparatus, or device. Accordingly, the power management tool and associated components may all be in the form of hardware elements in the computer system or software elements in a computer-readable format or a combination of software and hardware.

### Alternative Embodiments

It will be appreciated that, although specific embodiments of the invention have been described herein for purposes of illustration, various modifications may be made without departing from the spirit and scope of the invention. In particular, when allocating disk space for a first time write, the metadata manager will attempt to map the requests from the client to a physical disk with a matching inactivity threshold time. However, if no matching physical disk is available, then the metadata manager may direct the write request to a physical disk that is not in an idle state. In addition, in response to a read or write command that cannot be served from cached data, the metadata manager may start spinning up a disk before the actual I/O command has been received. This proactive process of spinning up a disk avoids delay associated with completing the I/O command. Preferably, the disk spin-up command it sent asynchronously from the metadata manager to the physical disk. Accordingly, the scope of protection of this invention is limited only by the following claims and their equivalents.

We claim:

1. A method for managing power in a distributed file system, comprising:
supporting simultaneous access to storage media by multiple client machines; and
asynchronously controlling a spin-state of a physical disk in said storage media in response to a data access request.

2. The method of claim 1, wherein said client machines are selected from a group consisting of: homogenous and heterogeneous.

3. The method of claim 1, wherein the step of asynchronously controlling spin-state of a physical disk in storage media includes a command selected from a group consisting of: spinning down an inactive physical disk, and spinning up a physical disk adapted to serve a data request.

4. The method of claim 3, further comprising spinning up of said physical disk before said data request is received by said physical disk.

5. The method of claim 1, further comprising allocating space on an active physical disk in response to a request to write data to said storage media.

6. The method of claim 1, further comprising tracking I/O activity of said physical disk with respect to time.

7. A computer system comprising:
a distributed file system having at least two client machines in simultaneous communication with at least one server and physical storage media;
a manager adapted to asynchronously control a spin-state of a physical disk in said storage media in response to presence of activity associated with said disk.

8. The computer system of claim 7, wherein said client machines are selected from a group consisting of: homogenous and heterogeneous.

9. The computer system of claim 7, further comprising a table adapted to organize I/O activity of said physical storage media with respect to time.

10. The computer system of claim 7, wherein said manager is adapted to control spin activity of said physical storage media, said control is selected from a group consisting of: spin down an inactive physical disk, and spin up a physical disk adapted to serve a data request.

11. The computer system of claim 7, further comprising a spin-up command adapted to be communicated asynchronously to said physical storage media.

12. The computer system of claim 11, wherein said spin-up command is adapted to be received by said physical disk before said data request.

13. An article comprising:
a computer useable medium embodying computer usable program code for managing power in a distributed file system, said computer program code including:
instructions for supporting simultaneous access to storage media by multiple client machines; and
instructions for asynchronously controlling a spin-state of a physical disk in said storage media responsive to a data access request.

14. The article of claim 13, wherein said client machines are selected from a group consisting of: homogenous and heterogeneous.

15. The article of claim 13, wherein said instructions for asynchronously controlling a spin-state of a physical disk in said storage media include program code selected from a group consisting of: spinning down an inactive disk, and spinning up a physical disk adapted to server a data request.

16. The article of claim 15, further comprising instructions for spinning up said physical disk before said data request is received by said physical disk.

17. The article of claim 13, further comprising instructions for allocating space on an active physical disk responsive to a request to write data to said storage media.

18. The article of claim 13, further comprising instructions for tracking I/O activity of said physical disk with respect to time.
